(19) United States
(12) Patent Application Publication
(10) Pub. No.: US 2008/0278857 A1
(43) Pub. Date: Nov. 13, 2008

(54) Flexible circuit board, motor equipped with the flexible circuit board, and hard disc drive apparatus

(76) Inventor: Hitoshi FUJINO, Ehime (JP)

Correspondence Address: WENDEROTH, LIND & PONACK L.L.P., 2033 K. STREET, NW, SUITE 800, WASHINGTON, DC, 20006, US

(21) Appl. No.: 12/111,074

(22) Filed: Apr. 28, 2008

(30) Foreign Application Priority Data
Apr. 27, 2007 (JP) 2007-118708

(51) Int. Cl. G11B 5/48

(52) U.S. Cl. 360/245.9

(57) ABSTRACT

By providing a flexible circuit board of a laminated structure capable of preventing contamination such as fluff, miniscule pieces of iron, or textile scraps from becoming affixed to an outer peripheral cross-sectional surface of the flexible circuit board. It is possible to prevent contamination from becoming affixed to an outer peripheral cross-sectional surface of a flexible circuit board by setting a pressure-sensitive layer in such a manner that the pressure-sensitive layer does not protrude into the outer periphery of the flexible circuit board while affixing the flexible circuit board comprising of an insulating base film layer having a pressure-sensitive layer, a circuit conduction layer, and a cover film layer to a structure.

### BACKGROUND OF THE INVENTION

1. Field of the Invention

The present invention relates to a flexible circuit board that can be attached to a structure of information equipment such as magnetic recording disc drive apparatus, and further relates to a laminated structure for a flexible circuit board attached via a pressure-sensitive layer to a spindle motor as the structure.

2. Description of the Related Art

Flexible circuit boards are widely used in electrical equipment such as compact, thin-type motors. Such motors have little space to fit a flexible circuit board and therefore make use of the flexibility and thinness of such flexible circuit boards. In recent years, in particular, such flexible circuit boards have been widely used with spindle motors employed by magnetic recording disc drive apparatus in order to utilize this flexibility.

FIG. 8A depicts a spindle motor 101 for use with a magnetic recording disc drive apparatus to which a flexible circuit board 100 of the related art is affixed and shows a base 107 as viewed from the side where the flexible circuit board 100 of the base 107 constituting the spindle motor 101 is affixed. FIG. 8B is a cross-section along Z-Z′ of the flexible circuit board 100 affixed to the spindle motor 101.

As shown in FIG. 8B, the laminated structure for the flexible circuit board 100 of the related art is such that a polyimide base film layer 102, a copper foil circuit conduction layer 103, and a polyimide cover film layer 104 are laminated via an adhesive layer (adhesive) 105. A pressure-sensitive layer 106 is then formed on a surface of the base film layer 102 in an upward direction for FIG. 8B and is affixed to a structure (base 107).

Further, with the flexible circuit board 100 of the related art, methods are widely employed where a large number of flexible circuit boards of shapes corresponding to various applications are cut from a single laminated product of the base film layer 102, the circuit conduction layer 103, the cover film layer 104, and the pressure-sensitive layer 106 laminated on top of each other. The shape of an outer peripheral end surface 108 of the flexible circuit board is therefore formed in the same plane along the cross-sectional surface of the outer peripheral end surfaces of each laminated layer.

When the flexible circuit board 100 of a laminated structure like this is affixed to the base 107 of a spindle motor for magnetic recording disc drive apparatus as the structure, the flexible circuit board 100 subjected to substantial pressing force is affixed to an affixing portion 107a of the base 107. This is so that gaps do not occur between the flexible circuit board 100 and the affixing portion 107a of the base 107 as a result of undulations in the affixing portion 107a of the flexible circuit board 100 of the base 107 being common.

Patent Document 1: Japanese Patent Publication Laid-open No. 2003-204123

### DISCLOSURE OF INVENTION

However, the following problems also occur when the flexible circuit board 100 is affixed to the affixing portion 107a of the base 107 by supplying substantial pressure.

There is fear that an outer peripheral end surface 106a of the pressure-sensitive layer 106 forming the outer peripheral end surface 108 of the flexible circuit board 100 will protrude from the outer peripheral end surface 108 as a result of the substantial pressing force. In this event, when assembling and checking the spindle motor 101 in a state where the pressure-sensitive layer 106 is sticking out, contamination such as fluff, miniscule pieces of iron, or textile scraps may adhere to the pressure-sensitive layer 106. The external appearance then becomes inferior as a result of affixed contamination becoming positioned between a main printed board (not shown) covering the flexible circuit board 100 and the base 107 or between the flexible circuit board 100 and the main printed board. In a worst case scenario, there is fear that short-circuiting may occur.

Specifically, as shown in FIG. 9, a spindle motor 400 equipped with a flexible circuit board 401 affixed to a base 407 has the flexible circuit board 401 arranged at a corner section of the base 407. The flexible circuit board 401 then makes contact with the main printed circuit board at plated portions for a U-phase, a V-phase, a W-phase, and a COM-phase or the like. Further, a circuit conduction layer 403 formed on the flexible circuit board 401 that is gold-plated (electrolytic plating) has as-yet unprocessed portions (cross-sectional portions) shown by arrows in the drawing, as shown in FIG. 10A.

With this configuration, there is fear that the pressure-sensitive layer will stick out from an outer peripheral portion of the flexible circuit board 401 when the flexible circuit board 401 is affixed with strong pressure, taking into consideration undulations in the surface of the base 407. In this case, the base unit with the flexible circuit board 401 affixed is conveyed to a clean room via a water-washing process. It is therefore also feared that extraneous material (fluff, metal particulate, etc.) may become affixed in the water-washing step in the above-mentioned state where the pressure-sensitive layer sticks out into an outer peripheral portion, which leads to defective appearance. When metal particulate etc. becomes affixed to the pressure-sensitive layer sticking out into an outer peripheral portion, as shown in FIG. 10B, there is fear that short-circuiting will occur between the base 407 and the circuit conduction layer 403.

In order to resolve the problems of the related art, it is an object of the present invention to provide a flexible circuit board capable of preventing contamination such as fluff, minuscule pieces of iron, or textile scraps from adhering to an outer peripheral cross-sectional surface of the flexible circuit board at the flexible circuit board mounted on a spindle motor.

### SUMMARY OF THE INVENTION

The flexible circuit board of the present invention is affixed to a structure via a pressure-sensitive layer and includes an insulating base film layer, a circuit conduction layer, and the pressure-sensitive layer. The insulating base film layer has a first surface on a side affixed to the structure and a second surface on an opposite side. The circuit conduction layer is laminated at the second surface at the base film layer. The pressure-sensitive layer is provided at the first surface at the base film layer, arranged further to the inside than an outer peripheral end of the base film layer when viewed in a plane.

According to the flexible circuit board of the present invention, it is possible to prevent contamination such as fluff, miniscule pieces of iron, or textile scraps from adhering to a surface of an outer peripheral end of a flexible circuit board whilst maintaining sufficient adhesion. It is then possible to dramatically improve the reliability of the magnetic recording disc drive apparatus because short-circuiting is prevented and the external appearance is not degraded.

### BRIEF DESCRIPTION OF THE DRAWINGS

FIG. 1A is a cross-sectional view of a hard disc drive mounted with a spindle motor to which the flexible circuit board of the first embodiment is affixed; FIG. 1B is a plan view showing the flexible circuit board affixed to a base surface;

FIG. 2A is a plan view of a flexible circuit board of the first embodiment; FIG. 2B is a cross-sectional view along line B-B′ of FIG. 2A;

FIG. 3A is a view illustrating a cross-section showing the situation before fixing the flexible circuit board of embodiment to the base; FIG. 3B is a state diagram of a cross-section showing the state of the pressure-sensitive layer before applying pressing force; FIG. 3C is a state diagram of a cross-section of the pressure-sensitive layer after applying pressing force;

FIG. 4A is a plan view showing a situation where a pressure-sensitive layer protrudes from the flexible circuit board taken as a comparative example; FIG. 4B is a cross-sectional view showing a situation where a pressure-sensitive layer protrudes from the flexible circuit board taken as a comparative example;

FIG. 5A is a frequency distribution chart of protrusion dimensions when the thickness of the pressure-sensitive layer is 0.1 mm; FIG. 5B is a frequency distribution view of protrusion dimensions when the thickness of the pressure-sensitive layer is 0.05 mm; FIG. 5C is a frequency distribution view of protrusion dimensions when the thickness of the pressure-sensitive layer is 0.025 mm;

FIG. 6 is a plan view of the base surface side of the spindle motor to which the flexible circuit board of the second embodiment of the present invention is affixed;

FIG. 7A is an enlarged view of the flexible circuit board of the second embodiment of the present invention; FIG. 7B is a view showing an outer peripheral end surface of the enlarged section of FIG. 7A;

FIG. 8A is a plan view of the base surface side of the spindle motor to which the flexible circuit board of the related art is affixed; FIG. 8B is a cross-sectional view along Z-Z′ of FIG. 8A;

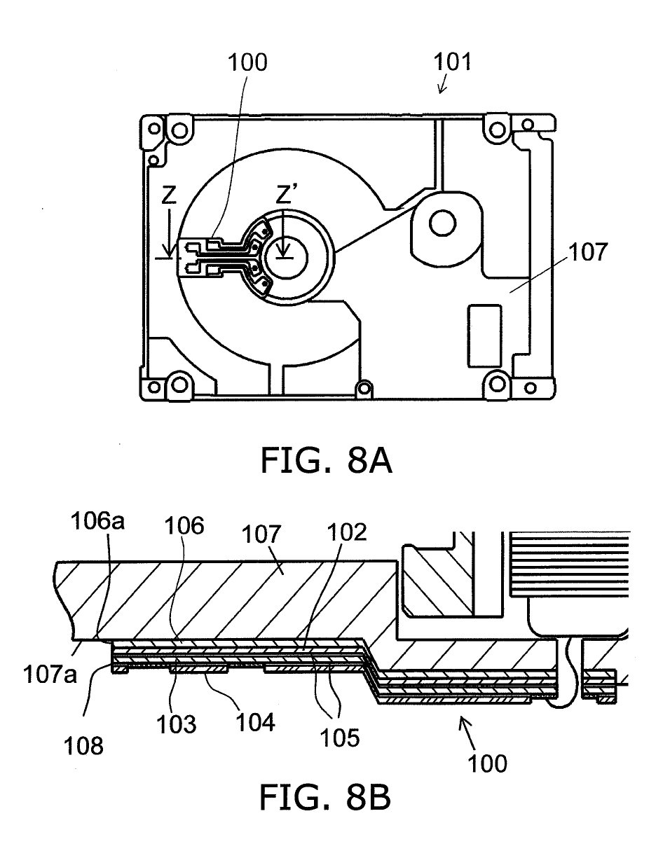

FIG. 9 is a plan view showing a configuration for a spindle motor mounted with a flexible circuit board of the related art; and

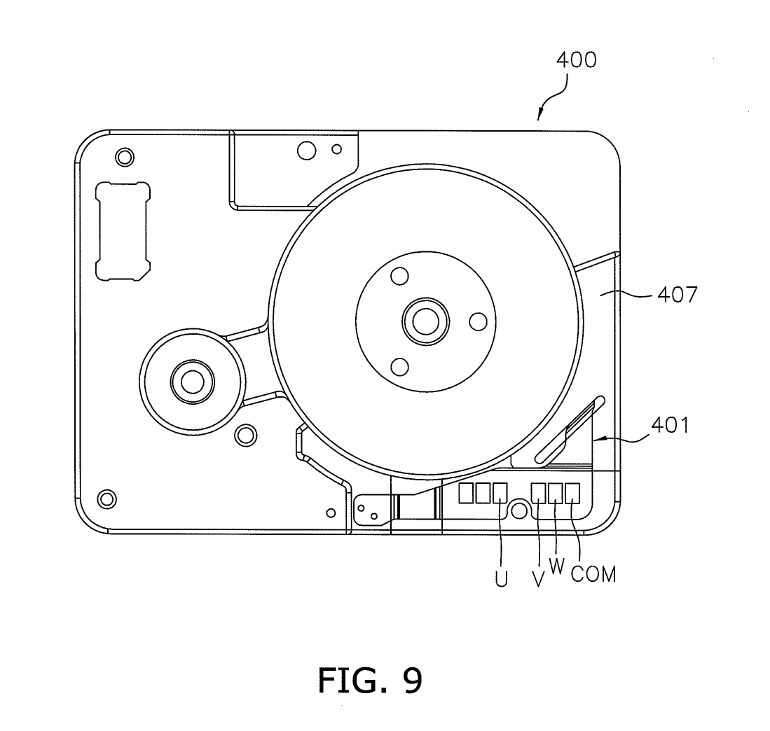

FIGS. 10A and B are enlarged views showing a configuration for the surroundings of a flexible circuit board mounted on a spindle motor of FIG. 9.

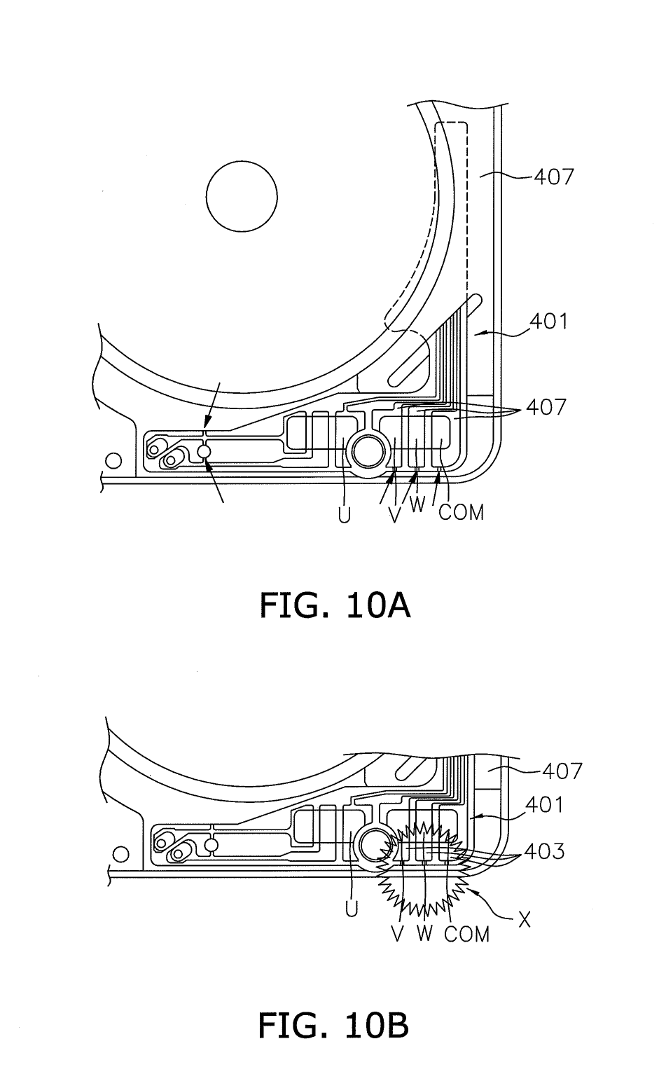

### DETAILED DESCRIPTION OF THE INVENTION

The following is a detailed description using the drawings of a flexible circuit board according to an embodiment of the present invention.

### First Embodiment

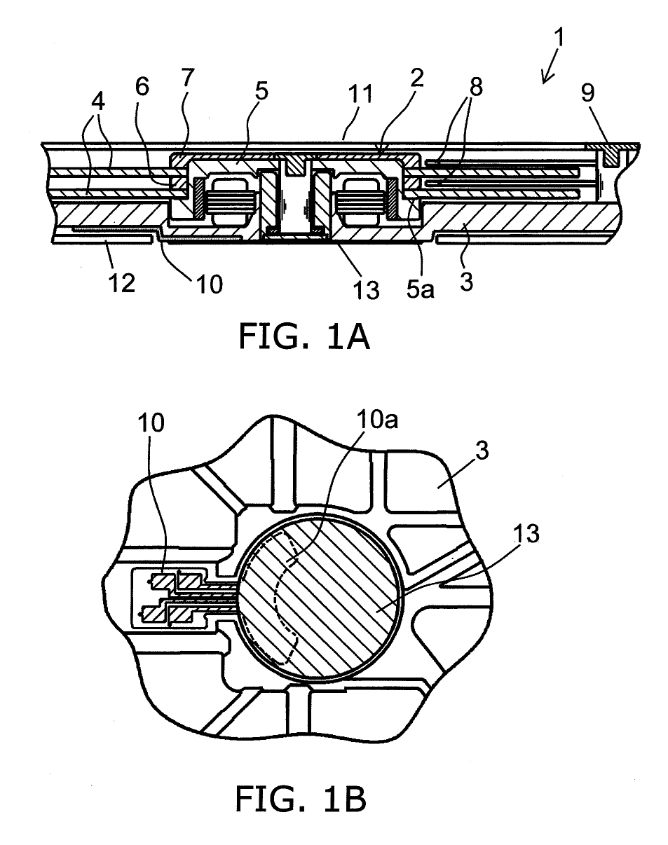

FIG. 1A shows a cross-sectional view of a hard disc drive 1 mounted with a spindle motor 2 affixed with a flexible circuit board 10 of the first embodiment.

A base 3 is made from materials such as aluminum or iron. The spindle motor 2 for rotating a magnetic recording disc 4 is arranged within an approximate recess of the base 3. The magnetic recording disc 4 is mounted at a disc mounting surface 5a of a hub 5 constituting the spindle motor 2. The magnetic recording disc 4 is fixed to the spindle motor 2 using a spacer 6 and a clamp 7.

A head unit 8 reads and writes data on the surface of the magnetic recording disc 4 by moving in a substantially elliptical orbit. One end of the head unit 8 is fastened to an actuator 9 and is arranged within a recess of the base 3.

A cover 11 is fixed to the base 3 so as to cover the spindle motor 2, the magnetic recording disc 3, the head unit 8, and the actuator 9 arranged within the recess of the base 3. The cover 11 ensures that contamination etc. does not permeate to within the recess of the base 3.

The flexible circuit board 10 for driving the spindle motor 2 and a main printed board 12 for starting up the hard disc drive 1 are fixed to an outside of the base 3 (lower side of FIG. 1A).

FIG. 1B shows a state when the flexible circuit board 10 is affixed to the outside of the base 3 (the main printed board is not shown).

The flexible circuit board 10 is affixed to an outer section of the base 3 having an undulating surface, as shown in FIG. 1B. A coil wire is then pulled out from a core (not shown) constituting the spindle motor 2. A portion 10a of the coil wire connected to the flexible circuit board 10 by soldering is covered by a seal 13. It is possible to prevent insulation defects or the like in the portion 10a connected by soldering and to prevent contamination or the like from permeating into the spindle motor 2 using the seal 13.

When a current is supplied from outside to the main printed board 12, the hard disc drive 1 with this configuration supplies current to the spindle motor 2 via the flexible circuit board 10 and rotates the magnetic recording disc 4.

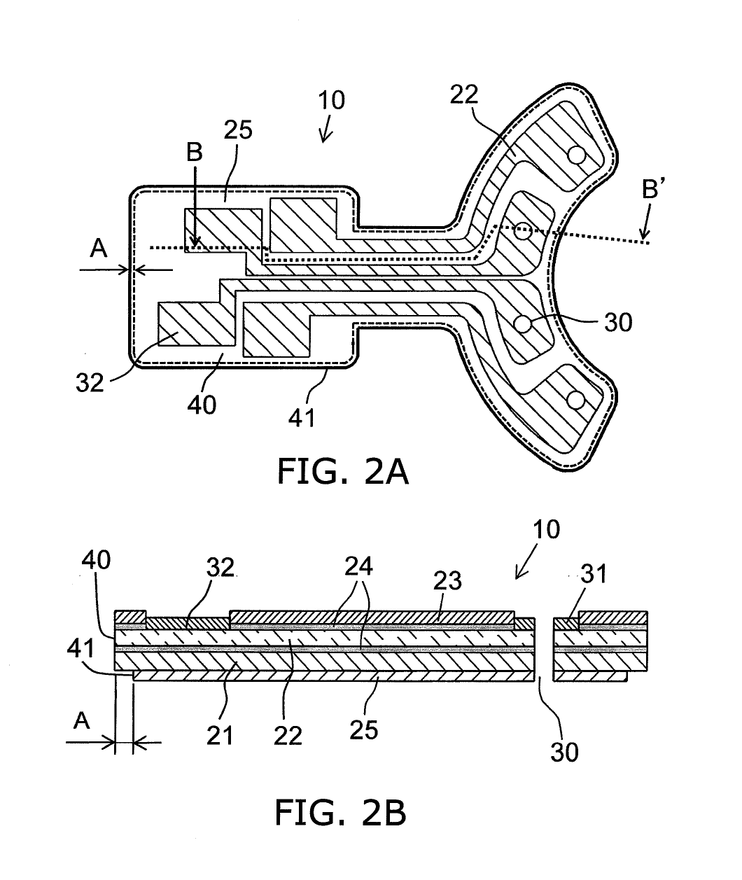

The flexible circuit board 10 required to drive the spindle motor 2 used for the hard disc drive 1 is now further described using FIG. 2.

FIG. 2A shows the surface of the side facing the main printed board of the flexible circuit board 10 in a state prior to being affixed to the base 3. Further, FIG. 2B is a diagram showing a cross-section along line B-B′ of the flexible circuit board 10 of FIG. 2A.

As shown in FIG. 2A and FIG. 2B, the flexible circuit board 10 is such that a polyimide base film layer 21, a copper foil circuit conduction layer 22, and a polyimide cover film layer 23 are laminated via an adhesive layer (adhesive) 24. A pressure-sensitive layer 25 is then formed on a surface (first surface) of the base film layer 21 in a downward direction of FIG. 2B and is affixed to the surface of the base 3 that is a structure.

A coil wire drawing out hole 30 is formed at the flexible circuit board 10. A plated layer 31 is then formed to make conduct the circuit conduction layer 22 and the coil wire. It is possible to conduct between the circuit conduction layer 22 and the coil wire by soldering the coil wire to the plating layer 31 since there is a conduction between the plating layer 31 and the circuit conduction layer 22. In this embodiment, the coil wire drawing out hole 30 is formed for the flexible circuit board 10 but this is by no means limited.

A plating layer 32 is formed in contact with the main printed board 12 at the flexible circuit board 10. Portions where the plating layers 31, 32 are formed are-not covered by the cover film layer 23. The plating layer 31 is electrolytic gold plated for ease of soldering and ease of conduction. The plating layer 32 is similarly electrolytic gold plated for ease of conduction. The plating layers 31, 32 can also be non-electrolytic plated other than being electrolytic plated.

The pressure-sensitive layer 25 is formed on the side where the plating layers 31, 32 are not formed. As shown in FIG. 2A and FIG. 2B, an outer peripheral end surface 41 of the pressure-sensitive layer 25 is provided with a difference A so as to have an outer periphery smaller than an outer peripheral end surface 40 of the flexible circuit board 10. In other words, the outer peripheral end surface 41 of the pressure-sensitive layer 25 is formed so as to be positioned on the inside of the outer peripheral end surface 40 of the flexible circuit board 10 when viewed in a plane.

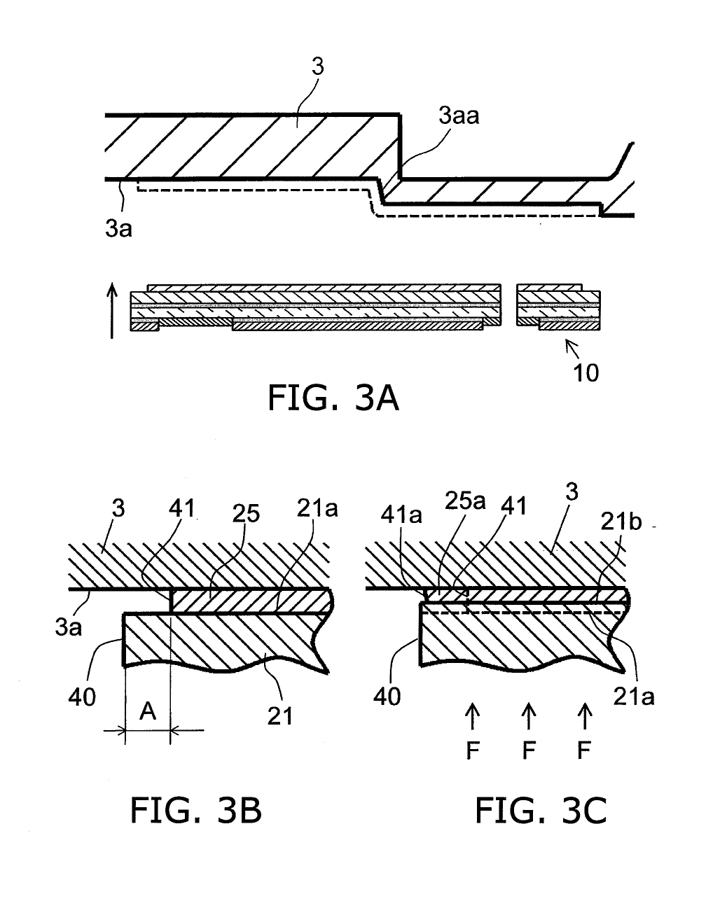

The role of the difference A is described using FIG. 3.

FIG. 3A is a cross-sectional view of a portion 3a for affixing the flexible circuit board 10 to the base 3 constituting the hard disc drive 1 and is a cross-sectional view of the flexible circuit board 10.

An inclined surface 3aa is formed at the portion 3a for affixing the flexible circuit board 10 to the base 3. This gives a form where the flexible circuit board 10 has to be reliably affixed in order to ensure that no gaps are formed. The following problems occur when gaps are formed between the flexible circuit board 10 and the affixing portion 3a of the base 3.

First, when the flexible circuit board 10 is affixed to the base 3 and the coil wire is soldered, the base 3 is washed (washed with water) in order to remove solder flux and eliminate contamination of the base 3. There is therefore fear that when there is a gap between the flexible circuit board 10 and the affixing portion 3a of the base 3 washing water will enter the gap in the washing process. In this event, it is feared that the flexible circuit board 10 will come away from the base 3. If the gap remains, it is possible that the dimensions of the gap between the flexible circuit board 10 and the main printed board 12 will be unstable in the event of shipping as manufactured goods (spindle motor). This can also cause contact failure. It may be possible that the hard disc drive 1 may then not start up.

In order to prevent this kind of problems from occurring, it is necessary to apply substantial pressing force F to the flexible circuit board 10. The flexible circuit board 10 is then forcibly affixed to the base 3 via the pressure-sensitive layer 25.

A description is now given of the state of the pressure-sensitive layer 25 while applying the pressing force F to the flexible circuit board 10, using FIG. 3B and FIG. 3C.

FIG. 3B shows the state before applying the pressing force F in order to affix the flexible circuit board 10 to the affixing portion 3a of the base 3. At this time, the flexible circuit board 10 is therefore in a temporarily affixed state, in order to ensure conduction with the main printed board 12 and to position the flexible circuit board 10 at a predetermined location on the base 3 because it is necessary to solder the coil wire to the flexible circuit board 10. In this state, the flexible circuit board 10 can easily come off and can easily be moved. From this state, the flexible circuit board 10 is therefore forcibly fixed to the base 3 by supplying the pressing force F.

FIG. 3C shows the state of the pressure-sensitive layer 25 during application of the pressing force F to the flexible circuit board 10. When a pressing force F is applied from the side of the cover film layer 23 of the flexible circuit board 10 (not shown), a surface 21a of the base film layer 21 is moved in the direction of the soft pressure-sensitive layer 25 as far as a surface 21b. As a result, the outer peripheral end surface 41 of the pressure-sensitive layer 25 moves in the direction of the outer peripheral end surface 40 of the flexible circuit board 10. However, because the difference A is formed, the outer peripheral end surface 41 of the pressure-sensitive layer 25 moves within the difference A. As a result, an outer peripheral end surface 41a depicted in FIG. 3C is formed and it is possible to prevent part of the pressure-sensitive layer 25 from moving further to the outside than the outer peripheral end surface 40 of the flexible circuit board 10 (left side in the drawing).

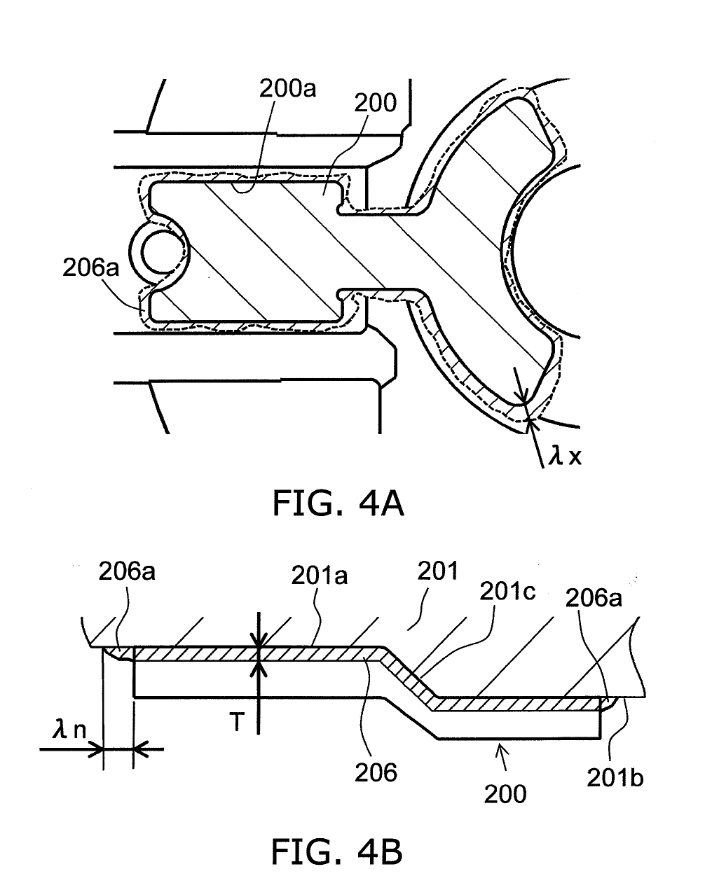

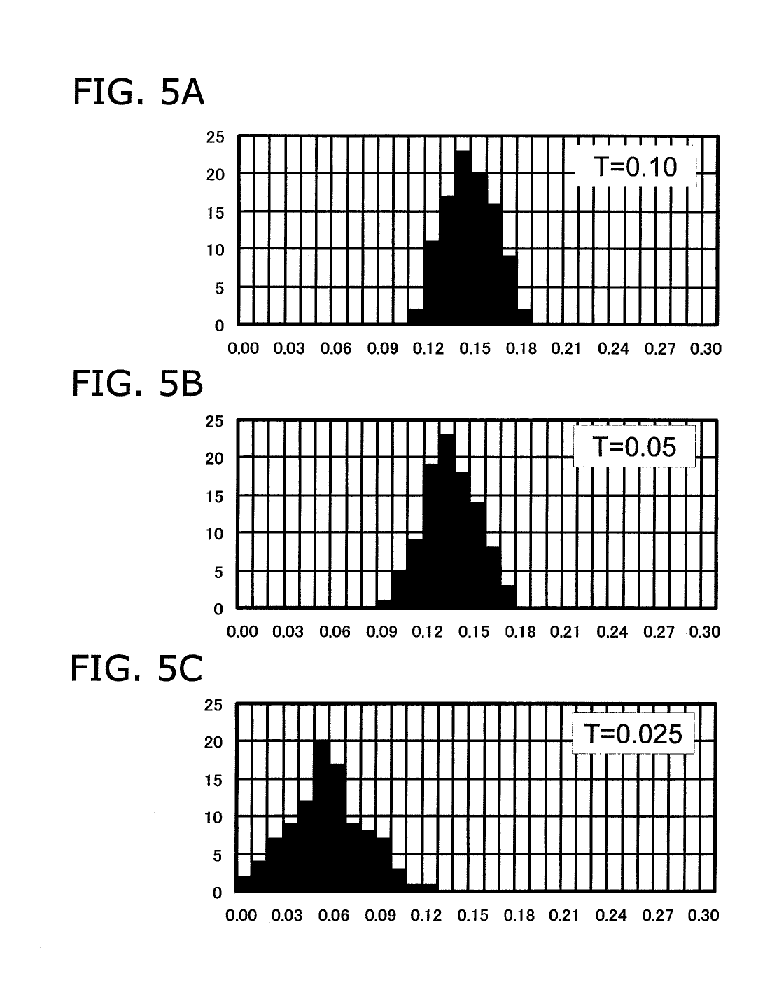

However, the extent of movement of the pressure-sensitive layer 25 to the outside (left side in FIG. 3C) of the outer peripheral end surface 40 of the flexible circuit board 10 differs depending on the shape of the surface 3a for affixing the flexible circuit board 10 to the base 3, the shape of the flexible circuit board 10, the thickness of the pressure-sensitive layer 25, and the strength of the pressing force F, and so on. A dimension (amount) λx by which the pressure-sensitive layer 25 protrudes from the outer peripheral end surface 40 is measured with a fixed pressing force F applied to the flexible circuit board 10. It is also possible for an optimum dimension for the difference A to be derived by taking the protruding dimension (amount) λx as the dimension of the difference A. This is described in detail in the following using FIG. 4 and FIG. 5.

First, conditions (1) to (4) for other than the protruding dimension λx are set as described in the following in order to derive the optimum dimensions for the difference A.

### (1) Shape of the Outer Periphery of the Flexible Circuit Board

The shape of the outer periphery of the flexible circuit board is decided according to the design of the main printed board of the hard disc drive and can not be limited. On this occasion, as shown in FIG. 4A, a flexible circuit board 200 that has an outer peripheral shape 200a is used.

### (2) Shape of the Base the Flexible Circuit Board is Affixed to

The shape of the base can also be decided according to the design of the hard disc drive as with the shape of the outer periphery of the flexible circuit board and is not limited. On this occasion, as shown in FIG. 4B, it is taken that a base 201 having an inclined surface 201c between a surface 201a and a surface 201b is used.

### (3) Pressing Force

The pressing force F is force of a magnitude of an order such that the base is not subject to plastic deformation. For example, the pressing force F is taken to be 30N (Newtons) in the case of affixing of a flexible circuit board to a spindle motor for use with a 1.8 inch hard disc drive. This is a value calculated so that the base 3 does not plastically deform through simulations for thickness of portions of the base 3 the flexible circuit board is affixed to and for pressing force. Calculation results of 300N for a spindle motor for use with a 2.5 inch hard disc drive and 20N for a spindle motor for use with a 1.0 inch hard disc drive were similarly obtained as the results of simulations. On this occasion, as hard discs become both thinner and more compact, it is taken that 30N that is a value for a spindle motor for use with a 1.8 inch hard disc drive is taken as the pressing force in this embodiment.

### (4) Thickness of the Pressure-Sensitive Layer

The thickness of the flexible circuit board is decided depending on the thickness of the base and the thickness of the main printed board. Namely, if the distance between the main printed board and the flexible circuit board is too great, conduction contact portions of both boards no longer make contact. When the distance is too close, this causes deformation of the main printed board occurring when the distance is too close. In this way, the distance between the main printed board and the flexible circuit board is decided depending on the design of the hard disc drive or the main printed board, as with the shape of the outer periphery of the flexible circuit board. The thickness of the flexible circuit board and the pressure-sensitive layer laminated at the flexible circuit board are also decided in the same way. As hard discs are becoming both thinner and more compact, on this occasion, a range of 0.025 mm to 0.1 mm that is an example of the dimensions of the pressure-sensitive layer for the flexible circuit board for a spindle motor for use with a hard-disc drive of 1.8 inches or less is used as a numeric range in this embodiment.

Distribution of the protruding dimension λx for the pressure-sensitive layer 206 were confirmed for one hundred samples under the conditions of (1) the shape of the outer periphery of the flexible circuit board, (2) the shape of the base the flexible circuit board is affixed to, (3) a fixed pressing force and (4) thickness of the pressure-sensitive layer for three points (0.025 mm, 0.05 mm, 0.100 mm) within a range of 0.025 mm to 0.10 mm.

Here, as shown in FIG. 4A, as a comparative example, the respective laminated layers of the outer peripheral end surface 200a of the flexible circuit board 200 constitute the same outer peripheral end surface. The protruding dimension λx for the pressure-sensitive layer 206 is therefore such that the pressure-sensitive layer 206 protrudes to the outside from the outer peripheral end surface 200a while the pressing force F is applied. An amount of protrusion of a protruding pressure-sensitive layer 206a protruding from the outer peripheral end surface 200a of the flexible circuit board 200 is then measured taking the amount of protrusion of the protruding pressure-sensitive layer 206a as λ, taking measurements at n locations on the outer periphery of the flexible circuit board 200, and taking an average value to be λx (=(λ1+λ2+ . . . +λn)÷n)

FIG. 5A shows distribution of the amount of protrusion λx of the protruding pressure-sensitive layer 206a when the thickness of the pressure-sensitive layer 206 is taken to be 0.10 mm. FIG. 5B shows distribution of the amount of protrusion λx of the protruding pressure-sensitive layer 206a when the thickness of the pressure-sensitive layer 206 is taken to be 0.05 mm. FIG. 5C shows distribution of the amount of protrusion λx of the protruding pressure-sensitive layer 206a when the thickness of the pressure-sensitive layer 206 is taken to be 0.025 mm.

From FIG. 5A to FIG. 5C, when the condition for the pressure-sensitive layer 206 to protrude the most is an adhesive layer of 0.10 mm thick, a maximum value λ a max for the amount of protrusion λx is 0.183 mm. Namely, it is understood that the pressure-sensitive layer does not protrude from the outer peripheral end surface of the flexible circuit board by setting the dimension of the difference A to 0.183 mm or more for the flexible circuit board of this embodiment.

Next, a value for λb+3σ is calculated using a central value λb of 0.133 mm for the distribution of the amount of protrusion λx for the results of FIG. 5B and a reference deviation value σ for confirming the variation. As a result, the value is 0.185 mm. The maximum value λ a max of the amount of protrusion λx of FIG. 5A is 0.183 mm, and is substantially the same as an upper variation limit of amount of protrusion λb+3σ calculated from the results of FIG. 5B. It can therefore be understood that protrusion does not take place by making the optimum dimension of the difference A 0.185 mm or more from the results of FIG. 5B, even when the used adhesive thickness changes in the range of 0.05 mm to 0.10 mm. Similarly, when the thickness of the pressure-sensitive layer 206 is 0.025 mm from the results of FIG. 5C, the maximum value λc max for the amount of protrusion λx is 0.121 mm and it can be understood that the amount of protrusion λx is comprised in the results of FIG. 5B are implied. It can then be understood that protrusion of the pressure-sensitive layer does not occur as a result of setting the dimension of the difference A to 0.185 mm.

However, there is a high possibility of the flexible circuit board coming away the base because of this difference A during assembling and checking of the spindle motor and hard disc drive due to the tendency of the adhesion with the base to fall just by making the difference A 0.185 mm or more. It is therefore necessary to decide an upper limit for the difference A. In this embodiment, this is taken to be 0.385 mm taking into consideration 0.2 mm as an example of a margin for affixing adhesive to the flexible circuit board.

A flexible circuit board where the difference A is set to 0.4 mm more disadvantageous condition than 0.385 mm in adherence is affixed to the base and assembly and checking of the spindle motor is carried out. It is then confirmed whether or not the flexible circuit board comes away the base. As a result, there was no flexible circuit board coming away the base.

From the above results, it can be deduced that the optimum dimensions for the difference A are from 0.185 mm to 0.4 mm.

It is therefore possible to prevent the outer peripheral end surface 41 of the pressure-sensitive layer 25 from protruding further outside than the outer peripheral end surface 40 of the flexible circuit board 10 by optimizing the dimension of the difference A. It is therefore possible to minimize the fear of contamination such as fluff, miniscule pieces of iron, or textile scraps becoming affixed in steps such as a washing step, a spindle motor assembly step, or a hard disc drive assembly step. As a result, it is possible to prevent short-circuiting occurring between the flexible circuit board and the main printed board, or between the flexible circuit board and the base. It is therefore possible to dramatically increase the reliability of the spindle motor or the hard disc drive. It is also possible for manufacturing costs to be reduced because it is no longer necessary to check for contamination such as fluff, miniscule pieces of iron, or textile scraps and complex operations to remove such contamination are no longer required.

### Manufacturing Method

With the flexible circuit board 10 of this embodiment, a large number of respective boards are formed from one large laminated product sheet. A method for manufacturing the flexible circuit board 10 is described in the following.

In a first step, adhesive is applied to the base film layer 21 and the circuit conduction layer 22 is affixed.

In a second step, a circuit is etched onto the circuit conduction layer 22.

In a third step, adhesive is applied onto the circuit conduction layer 22 and the cover film layer 23 is affixed. A hole is then formed in the cover film layer 23 in a state where a portion the coil wire is soldered to and a portion conducting with the main circuit are not covered (a state where circuit conduction is exposed).

In a fourth step, an electrode is connected to the cross-sectional surface that is an outer peripheral portion of the circuit conduction layer 22 and gold plating (electrolytic plating) is carried out at portions where the circuit conduction layer 22 is exposed.

In a fifth step, a pressure-sensitive sheet (pressure-sensitive layer 25+peeling sheet) are positioned and affixed to the base film layer 21 on the side where the circuit conduction layer 22 is not affixed. The flexible circuit board 10 of this embodiment is formed so that the pressure-sensitive layer of the pressure-sensitive sheet (pressure sensitive layer 25+peeling sheet) in this step has an outer periphery that is smaller than the base film layer 21.

Specifically, the pressure-sensitive sheet (pressure-sensitive layer 25+peeling sheet) is formed by forming the pressure-sensitive layer 25 on the peeling sheet and then punching out. During punching out, a punch of a shape smaller than the shape of the final flexible circuit board 10 (shape of the base film layer) is adopted. However, it is also feared that positioning will be difficult during affixing to the base film layer 21 when all of the surroundings are removed. A shape along an outer peripheral portion of the base film layer 21 at two or three locations is therefore adopted. The pressure-sensitive sheet that a plurality of pressure-sensitive layers 25 are connected to is affixed to the base film layer 21 while positioning using a portion of substantially the same size as the outer peripheral portion of the base film layer 21. It is therefore possible to make the pressure-sensitive layer 25 smaller than the cover film layer 23.

In a sixth step, the laminated product formed through the steps described above is punched out into predetermined shapes.

In this embodiment, it is possible to make the flexible circuit board 10 having a pressure-sensitive layer 25 with an outer peripheral end positioned inside of the outer peripheral end of the base film layer 21 when viewed in a plane.

### Second Embodiment

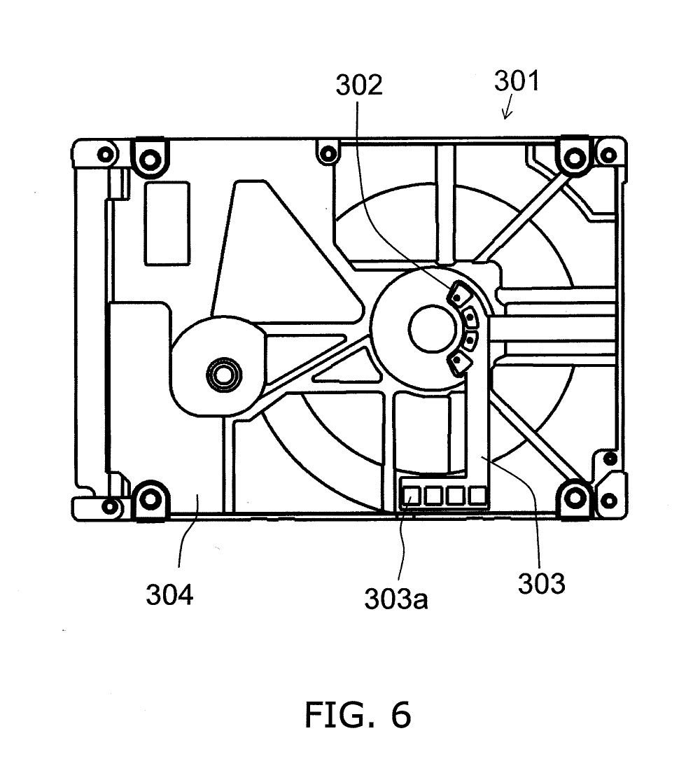

FIG. 6 shows a spindle motor 301 affixed with a flexible circuit board 302 of another embodiment of the present invention. As shown in FIG. 6, this embodiment differs from the flexible circuit board 10 of the first embodiment in that a plated portion 303a of a circuit body 303 for enabling conduction with a main printed board (not shown) of the flexible circuit board 302 is positioned in an outer periphery of a base 304.

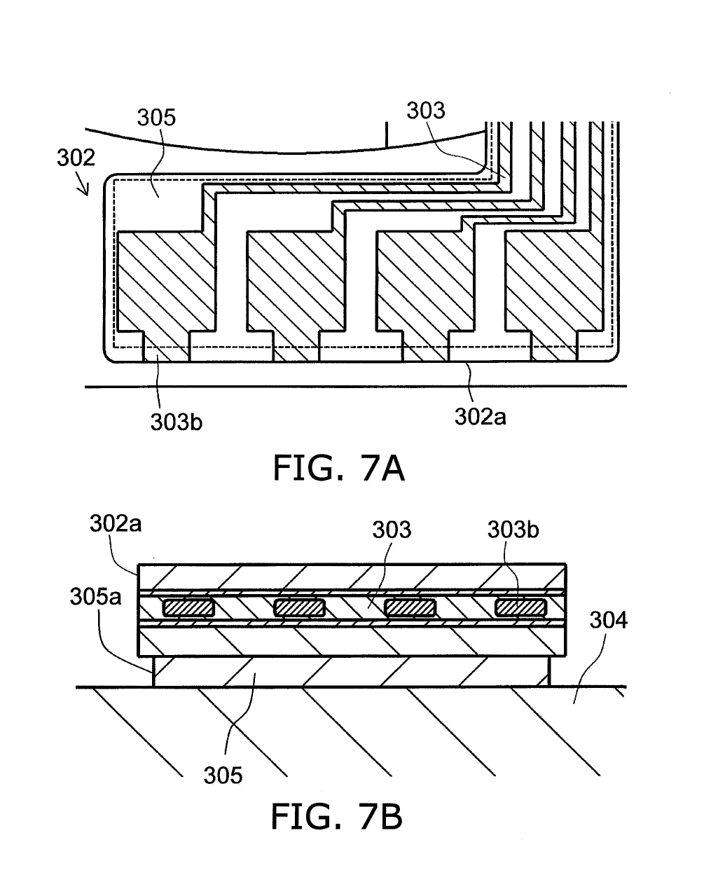

Further, as shown in FIG. 7A and FIG. 7B, there is a further difference from the first embodiment in that a cross-section 303b of the circuit conduction layer is exposed at an outer peripheral end surface 302a of the flexible circuit board 302 in order to perform gold plating at predetermined positions of the circuit conduction layer 303.

When a pressing force is applied to the flexible circuit board 302 under the same conditions (1) to (4) as for the first embodiment, a difference A is provided at a pressure-sensitive layer 305 as in the first embodiment. It is therefore possible to prevent an outer peripheral end surface 305a of the pressure-sensitive layer 305 from protruding from the outer peripheral end surface 302a of the flexible circuit board 302. It is therefore possible to suppress fluff, miniscule pieces of iron, or textile scraps from becoming attached to the pressure-sensitive layer. As a result, short-circuiting does not occur between the cross-section 303b of the circuit conduction layer 303 formed at the outer peripheral end surface 302a of the flexible circuit board 302 and the base 304, or with the main printed board. It is therefore possible to dramatically increase the reliability of the spindle motor and the hard disc drive. It is also possible for manufacturing costs to be reduced because it is no longer necessary to check for contamination such as fluff, miniscule pieces of iron, or textile scraps and complex operations to remove such contamination are no longer required.

According to the flexible circuit board of the present invention, a pressure-sensitive layer does not protrude and fluff, miniscule pieces of iron, and textile scraps etc. no longer become attached to the pressure-sensitive layer while affixing the flexible circuit board to a base having an undulating surface with a complex shape. This means that even if external force such as impacts or vibrations are applied to the spindle motor and the hard disc drive mounted with the spindle motor, electrical short-circuiting is prevented and it is possible to substantially increase reliability over long periods of time. This broadens the applicability as flexible circuit boards affixed to structures for information equipment such as magnetic recording disc drive apparatus etc.

1. A flexible circuit board affixed to a structure via a pressure-sensitive layer, the flexible circuit board comprising:
an insulating base film layer having a first surface on a side affixed to the structure and a second surface on an opposite side;
a circuit conduction layer laminated at the second surface at the base film layer; and
the pressure-sensitive layer provided at the first surface at the base film layer, arranged further to the inside than an outer peripheral end of the base film layer when viewed in a plane.

2. The flexible circuit board according to claim 1,
wherein the pressure-sensitive layer has a positioning section formed at part of the outer peripheral end so as to align with an end surface of the outer peripheral end of the base film layer.

3. The flexible circuit board according to claim 1, wherein a distance between the outer peripheral end of the base film layer and the outer peripheral end of the pressure-sensitive layer is 0.185 mm to 0.4 mm.

4. A motor equipped with the flexible circuit board according to claim 1.

5. The hard disc drive apparatus equipped with the motor according to claim 4.

6. A flexible circuit board comprising:
an insulating base film layer having a pressure-sensitive layer at a lower surface;
a circuit conduction layer laminated via an adhesive layer at an upper surface of the base film layer; and
an insulating cover film layer that covers an upper surface of a predetermined region of the circuit conduction layer via an adhesive layer and is laminated at the upper surface of the base film layer;
wherein the flexible circuit board is affixed to the structure using the pressure-sensitive layer of the base film layer, and
the outer peripheral end of the pressure-sensitive layer is made smaller than the outer peripheral end of the base film layer.
